(19) United States
(12) Patent Application Publication
(10) Pub. No.: US 2026/0093211 A1
(43) Pub. Date: Apr. 2, 2026

(54) TOWER CLOCK AND PROCEDURE FOR ITS OPERATION

(71) Applicants: Peter Peitsch, Erfurt (DE); Reinhard Jurisch, Meckfeld bei Bad Berka (DE); Fabian Jurisch, Bad Soden (DE)

(72) Inventors: Peter Peitsch, Erfurt (DE); Reinhard Jurisch, Meckfeld bei Bad Berka (DE); Fabian Jurisch, Bad Soden (DE)

(21) Appl. No.: 19/345,943

(22) Filed: Sep. 30, 2025

(30) Foreign Application Priority Data
Oct. 1, 2024 (DE) 10 2024 128 330.0

(51) Int. Cl. G04C 3/14; G04D 7/00

(52) U.S. Cl. CPC G04C 3/14; G04D 7/002

(57) ABSTRACT

The invention relates to a tower clock, comprising: a time display unit with a clock face and at least two hands; a stepper motor which is connected to the first hand (Z1) via a first clock shaft (W1); an acceleration sensor designed as a 2D acceleration sensor or as a 3D acceleration sensor, which is attached to the first hand (Z1) or to the first clock shaft (W1); a reading unit for reading out the acceleration sensor; and a control computer coupled to the reading unit and to the stepper motor, which is designed to receive a time signal (ZS), to receive a hand position signal (PS) of the acceleration sensor read out by the reading unit and to control the stepper motor as a function of the time signal (ZS) and of the hand position signal (PS). Furthermore, the invention relates to a method for operating the tower clock.

### CROSS-REFERENCE TO RELATED APPLICATION

This application claims priority to German application no. 10 2024 128 330.0 filed on Oct. 1, 2024, which is hereby incorporated by reference in its entirety.

### BACKGROUND

### 1. Field of Invention

The invention relates to a tower clock and a method for operating the tower clock.

### 2. Background Art

Tower clocks are generally known from the prior art. Such tower clocks have a clock face, an hour hand and a minute hand. The hands are connected to a clockwork and are moved by the clockwork.

### SUMMARY

The object of the invention is to provide a tower clock which is improved over the prior art and a method for operating the tower clock which is improved over the prior art.

In accordance with the invention, the object is achieved by a tower clock and a method for operating the tower clock according to the appended set of claims.

Advantageous embodiments of the invention are the subject of the subclaims.

A tower clock has a time display unit with a clock face and at least two hands. For example, the first hand is a minute hand and the second hand is an hour hand. Alternatively, the time display unit has three hands, for example. The first hand is then a sweep hand, the second hand is the minute hand and the third hand is the hour hand.

The term tower clock refers in particular to an immobile clock, in particular a clock permanently installed in a building, for example in a tower, for example in a church tower or clock tower, or at a railroad station or other building. The term tower clock is understood in particular to mean a large clock, especially a clock which is intended for the public and is intended to be or is visible from great distances.

The tower clock also has a stepper motor which is connected to the first hand via a first clock shaft. The first clock shaft is firmly connected to the first hand. In particular, the clock face and first hand have a parallel alignment. In particular, the hand shaft and the first hand have an orthogonal alignment. In particular, the hand shaft and clock face have an orthogonal alignment.

The tower clock also has an acceleration sensor designed as a 2D acceleration sensor or as a 3D acceleration sensor, which is attached to the first hand or to a part mechanically connected directly to the first hand, advantageously in a rotationally fixed manner, for example to the first clock shaft or to a gear wheel, in particular attached in such a way that the acceleration sensor can determine a respective angular position of the first hand via the gravitational field of the earth. The acceleration sensor is designed in particular as a passive RFID sensor transponder. This acceleration sensor makes it possible to determine its orientation, i.e. in particular the inclination or angular position, in two or three dimensions, i.e. in the axis directions of a two-dimensional or three-dimensional coordinate system, via a reference to the gravitational acceleration g of 9.81 m/s². Since the acceleration sensor is attached to the first hand or to the first clock shaft, it can also be used to determine the orientation of the first hand and thus the actual position of the first hand.

In particular, the 2D acceleration sensor has two, in particular static, acceleration sensor units, which are arranged rotated by 90° to each other and each measure the acceleration. The 3D acceleration sensor has in particular three, in particular static, acceleration sensor units, which are arranged rotated by 90° to each other and each measure the acceleration. In particular, the acceleration sensor unit with the steepest change in the acceleration measurement, i.e. in particular at the zero crossing of the sine function, is used for inclination measurement and thus for determining the position of the hand in the respective quadrant of the hand rotation.

The tower clock also has a reading unit which is designed, set up and arranged for reading out the acceleration sensor, in particular for contactless reading. The reading unit is designed in particular as an RFID reading unit for reading the acceleration sensor, which is designed as an RFID sensor transponder. The reading unit is arranged in such a way that it is within reading range of the acceleration sensor at all times, i.e. in any position of the acceleration sensor. In particular, the reading unit is arranged in a fixed position. In the case of several acceleration sensors that are read out with the same reading unit, the reading unit is arranged in such a way that it is within reading range of the respective acceleration sensor at all times, i.e. in any position of the respective acceleration sensor.

The use of RFID technology, i.e. the acceleration sensor designed as an RFID sensor transponder and the RFID reading unit, enables wireless and contactless reading of the acceleration sensor and, in particular, a small design of the acceleration sensor so that it can be attached to the first hand or to the first watch stem.

The acceleration sensor of this RFID sensor transponder is designed in particular as a MEMS acceleration sensor. The abbreviation MEMS stands for microsystem or micro-electromechanical system. This is a miniaturized device, an assembly or a component whose components have the smallest dimensions in the range of 1 μm and interact as a system.

The tower clock also has a control computer coupled to the reading unit and to the stepper motor, which is designed to receive a time signal, to receive a hand position signal of the acceleration sensor read out by the reading unit and to control the stepper motor as a function of the time signal and the hand position signal. In particular, the reading unit is coupled to the control computer via a cable, in particular a data transmission cable and power supply cable, in particular for data transmission and power supply to the reading unit.

The time signal used is, for example, the time of an internal quartz clock of the control computer, a time signal from the DCF77 time signal transmitter, the Internet time or the time reference of a GPS satellite.

The hand position signal of the acceleration sensor contains in particular a statement regarding the respective hand position of the first hand, in particular in the form of acceleration values in two or three dimensions resulting from the effect of the acceleration due to gravity on the acceleration sensor or in the form of corresponding sensor values. In particular, it is intended that the control computer determines the actual hand position from this hand position signal. The stepper motor is then controlled by the control computer as a function of the time signal and of the actual hand position determined by means of the hand position signal if this actual hand position deviates from a hand position corresponding to the time signal, at least if this deviation is above a predetermined limit.

The acceleration sensor designed as a passive RFID sensor transponder and the reading unit designed as an RFID reading unit operate, for example, in the high frequency range, or HF range for short, in particular at 13.56 MHz, or in the ultra-high frequency range, or UHF range for short, in particular at 900 MHz.

If the acceleration sensor designed as a passive RFID sensor transponder and the reading unit designed as an RFID reading unit are designed for the HF range, this enables the acceleration sensor to be read by means of the reading unit up to a distance of 5 m from the acceleration sensor, for example. The acceleration sensor designed as a passive RFID sensor transponder, in particular including its antenna or antennas, is then elongated, for example, and has a length of 17 cm. This acceleration sensor is attached to the first hand, for example, with its longitudinal extension extending parallel to the longitudinal extension of the first hand. Alternatively, this acceleration sensor is attached to the first clock shaft, for example, with its longitudinal extension extending in the axial direction of the first clock shaft. Due to the large range and the resulting large distance between the acceleration sensor and the reading unit, the reading unit does not have to be in the immediate vicinity of the acceleration sensor and therefore also not in the immediate vicinity of the first hand when it is arranged on the first hand. This means that even if the first hand, which is very large in tower clocks, rotates and the acceleration sensor is attached to the first hand, the acceleration sensor can be read out reliably at any time using the fixed reading unit.

If the acceleration sensor, designed as a passive RFID sensor transponder, and the reading unit, designed as an RFID reading unit, are designed for the UHF range, this enables the acceleration sensor to be read by means of the reading unit up to a distance of 5 cm from the acceleration sensor, for example. The acceleration sensor can be advantageously designed to be particularly small in this case. It is then attached, for example, to the first clock shaft or to another part that is mechanically connected directly to the first hand, preferably in a rotationally fixed manner, in particular to a part that does not change its distance from the immovably arranged reading unit, so that the acceleration sensor does not change its distance from the reading unit or only changes it slightly due to the rotation of this part and thus always remains within this distance from the reading unit. This enables reliable reading of the acceleration sensor at all times by means of the immovably arranged reading unit.

In a method for operating the tower clock according to the invention, it is thus provided in particular that the hand position signal is read out at predetermined time intervals of, for example, 30 seconds, an actual hand position is determined therefrom, in particular in the control computer, and the determined actual hand position is compared, in particular in the control computer, with a hand position corresponding to the time signal, in the event of a deviation of the determined actual hand position from the hand position corresponding to the time signal which is above a predetermined limit, a number of steps of the stepper motor corresponding to the deviation is calculated, in particular by the control computer, and the stepper motor is controlled, in particular by the control computer, to execute the calculated number of steps.

The tower clock described here thus has in particular no conventional clockwork, i.e. neither a conventional mechanical clockwork nor a conventional electrical clockwork, for example quartz clockwork, but the adjustment of the hands, in particular of the first hand and in particular the adjustment of the second hand via the first hand and, if present, of the third hand, takes place only by means of the stepper motor, by its control by means of the control computer as a function of the time signal and of the actual hand position determined by means of the hand position signal.

The solution according to the invention makes it possible to control the actual hand position of the first hand by means of the acceleration sensor. For example, such an acceleration sensor is also attached to the second hand or to a second clock shaft permanently connected to the second hand. If the clock display unit has three hands, such an acceleration sensor is also attached to the third hand or to a third clock shaft permanently connected to the third hand, for example. The multiple acceleration sensors, especially if they are each designed as RFID sensor transponders, can be read out with the same reading unit, especially the RFID reading unit. There is therefore advantageously only one common reading unit provided, even with several acceleration sensors. The actual hand position is then determined for the second hand equipped with an acceleration sensor and, if present and equipped with an acceleration sensor, also for the third hand in the same way as for the first hand.

The position of the respective hand can change due to external influences such as wind loads, deformation, mechanical ageing of drives and gearboxes. In addition, when cardan joints are used in the drive train of the hands, the so-called gimbal error occurs, which can also lead to systematic time display errors. Up to now, this has not been recorded and there is therefore a risk that the actual position of the respective hand deviates from an intended position and therefore an incorrect time is displayed.

The term “gimbal error” refers to the uneven transmission of rotational speed of a universal joint during a 360° rotation. During a 360° rotation of a cardan shaft, for example, gimbal errors occur at the universal joints. This refers to uneven transmission of the rotational speed. During a complete rotation, the outgoing shaft periodically rotates twice faster and twice slower, but in total the same as the incoming shaft of the universal joint. The greater the flexion of the universal joint, the greater the difference in rotational speed between the incoming and outgoing shafts.

Furthermore, the solution according to the invention offers the realization of a tower clock that ensures an accurate time display at all times with very little effort, in particular with very little mechanical effort, since no large, complicated, maintenance-intensive mechanical clockworks that are difficult and expensive to maintain are required.

In the solution according to the invention, the hand position is determined from a gravitational inclination measurement by means of the acceleration sensor. By comparing this determined hand position with the time according to the time signal, it is determined whether the hand position corresponds to a hand position corresponding to the time or not. If the hand position determined by the acceleration sensor deviates from the hand position according to the time, the stepper motor is activated by the control computer to adjust the hand position, at least if the deviation is above the specified limit. This takes place until the new hand position determined by the acceleration sensor matches the hand position according to the time or the deviation is within the specified limit.

Low energy consumption is achieved through clocked control. An adjustment cycle, i.e. the time interval for checking the hand position using the acceleration sensor and for any necessary readjustment by controlling the stepper motor, is advantageously freely programmable. For example, the adjustment cycle, i.e. the time interval, is 30 seconds if the first hand is the minute hand, i.e. every 30 seconds its hand position is checked in the manner described and, if necessary, readjusted by controlling the stepper motor.

The limit, i.e. the permissible deviation of the hand position determined by the acceleration sensor from the hand position according to the time of the time signal, is advantageously freely programmable.

The use of the stepper motor enables targeted, calculable correction control via the equation for calculating the stepper steps of the stepper motor.

Advantageously, a basic routine for self-calibration of the acceleration sensor is provided for each 360° hand revolution. The reference signal is the acceleration due to gravity of 9.81 m/s². This compensates in particular for ageing of the acceleration sensor and a temperature-dependent transfer function.

The solution according to the invention also makes it particularly easy to change the tower clock from daylight saving time to standard time and vice versa. By determining the actual hand positions of the minute and hour hands using an acceleration sensor in each case, the adjustment process carried out by the stepper motor can be controlled.

In one embodiment, the tower clock has a mechanical converter via which the stepper motor is connected to the first clock shaft.

In one embodiment, the tower clock has a cardan joint between the first clock shaft and an output shaft of the stepper motor or the mechanical converter. The cardan joint is connected on the one hand to the first clock shaft and on the other hand to the output shaft of the stepper motor or the mechanical converter.

In one embodiment, the reading unit has a feed-through opening for the first clock shaft and is arranged coaxially to the first clock shaft, wherein the feed-through opening has a larger diameter than the first clock shaft arranged guided through the feed-through opening. This is a structural form of the reading unit for optimum mounting in the area of the first watch shaft. By making the diameter of the feed-through opening larger than the diameter of the first clock shaft, friction between the rotating first clock shaft and the stationary reading unit is avoided.

In one embodiment, the acceleration sensor is elongated and/or arranged in an elongated housing and arranged on the first hand. Elongated means in particular that a length is greater, in particular much greater, in particular many times greater, than a width and/or a diameter. This is a structural form of the acceleration sensor for optimum mounting on standard hands of tower clocks. For example, the acceleration sensor and/or its housing has a length of 2 cm to 15 cm. The RFID sensor transponder is, for example, a UHF RFID sensor transponder with a dipole antenna at lambda-half or lambda-quarter with respect to the wavelength of the radio signal, in particular the hand position signal.

In one embodiment, the acceleration sensor is round and/or arranged in a round sensor housing and attached to the first clock shaft coaxially to the first clock shaft. This is a structural form of the acceleration sensor for optimum mounting on the first clock shaft, which is firmly connected to the first hand.

In one embodiment, the mechanical converter is connected to the second hand via a second clock shaft, whereby the first clock shaft and the second clock shaft in the mechanical converter are coupled to each other via a gearbox. In this embodiment, only the first hand, for example the minute hand, is moved directly by the stepper motor. The second hand, for example the hour hand, is then also adjusted via the adjustment of the first hand.

If the time display unit has three hands, the mechanical converter is advantageously connected to the second hand via the second clock shaft and to the third hand via the third clock shaft, whereby the first clock shaft, the second clock shaft and the third clock shaft are coupled to each other in the mechanical converter via the gearing. In this embodiment, only the first hand, for example the sweep hand, is moved directly by the stepper motor. The second hand and the third hand, for example the minute hand and the hour hand, are then also adjusted via the adjustment of the first hand.

In one embodiment, the mechanical converter is designed as a distributor via which the stepper motor is connected to a further first hand of at least one further time display unit or to further first hands of several further time display units via a further first clock shaft or via a respectively one further first clock shaft. This embodiment is intended, for example, for tower clocks which each have a time display unit on two, three or four sides of a structure, in particular a tower. In this embodiment, all the first hands are then moved by the same stepper motor. It can be provided, for example, that the acceleration sensor or the acceleration sensors are only arranged on the first hand or on the hands of one of the time display units or are arranged on the first hand or on the hands of several or all of the time display units. Since it can be assumed that the influences described above, which can lead to changed hand positions, are the same for all time display units of such a tower clock with several time display units, equipping the first hand or the hands of one of the time display units with acceleration sensors is sufficient.

As an alternative to this solution, in the case of several time display units on a structure, in particular a tower, it is possible, for example, for each of the time display units to belong to a separate tower clock which is designed as described here. However, it can be provided that at least the control computer is then used for all of these individual tower clocks. This means that the control computer of these tower clocks is then the same. However, the tower clocks then in particular each have their own stepper motor and their own acceleration sensor or several own acceleration sensors.

In one embodiment, the control computer is connected via a data transmission network to a time signal generator (NTP server) and/or to an operator server of a tower clock operator. In the age of digitalization, this solution enables practical and simple remote maintenance thanks to the network capability.

The solution described enables the detection of the hand position on the tower clock by means of the acceleration sensor on the first hand or by means of the acceleration sensors on the hands for automatic, contactless reading of the hand position.

The described detection of the hand position, in particular of the first hand, by means of the acceleration sensor can be used as an alternative to the tower clock solution described here, for example also on hand instruments, in particular in order to be able to read out their analogue hand display and thus, for example, a physical variable measured by the hand instrument automatically and contactlessly, in particular digitally. For this purpose, it is only necessary that the hand instrument is immobile, i.e. permanently installed, and that the acceleration sensor is attached to the hand or to the hand shaft permanently connected to the hand in the manner described above and that the reading unit is provided for reading out the acceleration sensor. For example, the hand position can then be determined in the control computer connected to the reading unit in the manner described from the recorded acceleration values of the acceleration sensor resulting from the acceleration due to gravity and a respective present value of the measured physical quantity can be determined from this. The control computer can then, for example, initiate predetermined measures, such as controlling a system or issuing a warning, depending on the determined hand position and/or the respective value of the measured physical quantity.

In the solution described, both with regard to the tower clock and with regard to the hand instrument, the main aspect is to use gravity and thus the acceleration due to gravity g of 9.81 m/s² as a reference variable, especially when the clock faces are preferably vertical. In particular, the clock face should be vertical if the acceleration sensor is designed as a 2D acceleration sensor.

It is essential for the solution described that the acceleration sensor is mechanically connected directly to the hand or to a directly coupled clock shaft or hand shaft or to another part directly connected to the hand, in particular in a rotationally fixed manner, and is read out wirelessly by means of the reading unit. Reading out the acceleration sensor means in particular that the hand position signal, containing in particular an acceleration vector or, in the case of a vertical clock face, at least two acceleration components, i.e. at least acceleration values measured by the two acceleration sensor units, and, for example, additionally a sensor ID, i.e. a sensor identification of the acceleration sensor, are transmitted from the acceleration sensor to the reading unit. The sensor ID is particularly important if several acceleration sensors are read out by the same reading unit.

In the solution described, the time is set as a correction variable, i.e. not time-synchronized as with clockworks according to the state of the art, but from the difference between the real time according to the time signal and the determined actual hand position. This eliminates all other influencing variables or disturbance variables.

Deviations in the sensor characteristic curve, for example over the long term or the temperature, are advantageously compensated for by a self-calibration procedure. The prerequisite is that the acceleration sensor performs at least one 180° rotation in the constant earth gravitational field and the gravitational constant at the respective earth point can then be used as a calibration reference. For this purpose, it is necessary to determine the maximum and minimum acceleration of the respective acceleration sensor, in particular of the respective acceleration sensor unit of the acceleration sensor, during a rotation and to program the calibration value determined from this into the acceleration sensor, in particular into the respective acceleration sensor unit of the acceleration sensor, or, for example, into the overall system of the tower clock or into the reading unit or into the control computer.

In particular, it is intended that what has been described above with regard to the first hand, in particular with regard to the determination of the hand position by means of the acceleration sensor, also applies to the second hand and, if present, also to the third hand. By applying the RFID anti-collision principle and the unique hand identification, i.e. the unique identification of the acceleration sensor assigned to the respective hand, all acceleration sensors can be read out with the same RFID reading unit.

As already mentioned, in the solution described here, the time is set as a correction variable, i.e. not time-synchronized as in the state of the art, but from the difference between the real time according to the time signal and the determined hand position according to the hand position signal.

Advantageously, the control computer, in particular the programmable control computer, in particular in the form of a controller, is used for the entire control of this asynchronous clock. The control computer runs continuously, i.e. permanently, for the duration of the clock operation. It executes a program corresponding to the solution described, which in particular implements the procedure for operating the tower clock.

In this procedure for operating the tower clock, for example, the usual setups for the operating system are first executed after the control computer is started and, in particular, the time synchronization of the control computer is also executed, which serves as a reference time (real time), i.e. as a time signal. This time can be an internal quartz clock of the control computer, the time signal transmitter DCF77, the Internet time or the time reference of a GPS satellite.

Once this has been done successfully, the data from the acceleration sensor is advantageously read out and the respective hand position is calculated in degrees, hours, minutes or seconds and compared with the real time, i.e. with the time according to the time signal. If there is a difference, the number of steps of the stepper motor forward or backward is calculated from this, in particular according to a transmission ratio of the clock gear, which is arranged in the mechanical converter, and the angular step widths of the stepper motor. The transmission ratio and angular step width are advantageously adjustable parameters of the program. They therefore allow the program to be applied variably to different hardware components of tower clocks.

The reading of the acceleration sensor and the control of the stepper motor is carried out until the specified limit is reached. The limit is specified in particular depending on the resolution of the hand position on the clock face. The higher the resolution on the clock face, the lower the limit should be set, as a deviation is then more noticeable than with a lower clock face resolution.

This limit is advantageously a selection parameter of the program. Ideally, the controller reaches this limit with a program loop. This means that the deviation of the actual hand position from the hand position that should be present according to the time signal and the resulting steps of the stepper motor are advantageously calculated in such a way that the hand position is within the limit after the stepper motor has been activated and the calculated steps have been executed.

Advantageously, the actual hand position is then determined again and its deviation from the hand position, which should be present according to the time signal, is checked again. If the actual hand position is outside the limit, the required steps of the stepper motor are calculated again and the stepper motor is controlled accordingly in order to execute the calculated steps. This is advantageously repeated until the actual hand position is within the specified limit. Ideally, however, this is already the case after the first hand adjustment by means of the stepper motor, so that no repetitions are necessary.

This process is repeated at predetermined, preferably adjustable, time intervals, for example every 30 seconds. This time interval is sufficient for tower clocks to achieve a reasonable accuracy of the time display, especially if the tower clock does not have a sweep hand, but only a minute hand and hour hand. Energy savings can be achieved with this time interval. The solution described therefore works in a very energy-saving manner. The stepper motor, as the most energy-intensive element, is advantageously operated at a duty cycle of approx. 1:50 to 1:100.

All measured variables and adjustment variables, i.e. in particular executed steps of the stepper motor as well as the determined hand position signals and/or the hand positions determined therefrom, are advantageously stored in a non-volatile data memory and are thus available for data analysis, in particular for the self-calibration routine of the acceleration sensor. The acceleration sensor advantageously has a simple option for entering calibration constants.

In order to avoid having to use elaborately calibrated acceleration sensors, a routine for self-calibration is performed, in particular as part of the procedure for operating the tower clock, which is performed continuously, in particular cyclically, during operation of the tower clock and/or during initial installation.

During the initial installation, for example, a self-calibration function is called up in the program, which first performs at least a 360° rotation of the first hand or the respective hand in order to determine the maximum and minimum accelerations, from which the calibration constants for the respective acceleration sensor, in particular for its acceleration sensor units, are determined. Once this has been run through and meaningful values have been determined, normal clock operation can begin.

It is advantageous that this calibration routine can be carried out again for each hand rotation in normal clock operation without having to perform a special 360° rotation of the hand again in deviation from normal clock operation, as all measured values for determining the maximum and minimum accelerations are available in the data memory, for example for an hourly rotation of the minute hand, as described above.

In particular, this procedure also means that temperature influences on the acceleration sensor are automatically compensated for. It can be assumed that large temperature fluctuations on tower clocks are slower than one hour. Experience has shown that the calibration values from the measurement in the minute hand can also be transferred to the acceleration sensor of the hour hand if the same acceleration sensors from the same production series are used.

### BRIEF DESCRIPTION OF THE DRAWINGS

Examples of embodiments of the invention are explained in more detail below with reference to drawings.

FIG. 1 schematically shows an embodiment of a tower clock,

FIG. 2 schematically shows a further embodiment,

FIG. 3 schematically shows a further embodiment,

FIG. 4 schematically shows a representation of a possible arrangement of an acceleration sensor and a reading unit,

FIG. 5 schematically shows a representation of a further possible arrangement of the acceleration sensor and the reading unit,

FIG. 6 schematically shows a program flow chart of a method for operating the tower clock, and

FIG. 7 schematically shows a program flow chart of a sensor self-calibration.

Corresponding parts are marked with the same reference signs in all figures.

### DETAILED DESCRIPTION OF SPECIFIC EMBODIMENTS

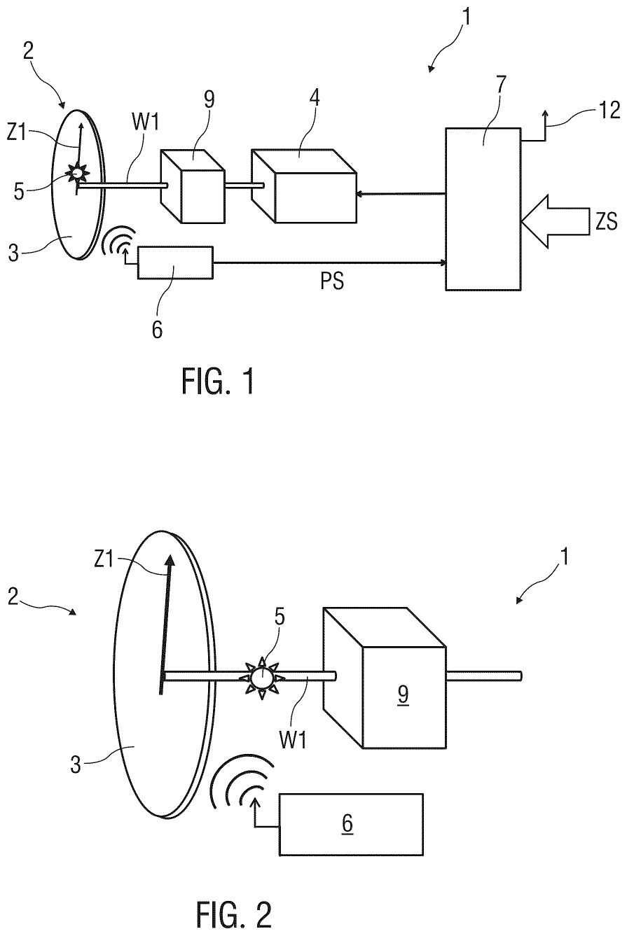

With reference to FIGS. 1 to 7, a tower clock 1 and a method for its operation are described below.

The tower clock 1 has a time display unit 2 with a clock face 3 and at least two hands. In the examples shown, only the first hand Z1 is shown, which is in particular a minute hand. The second hand, which is not shown, is in particular an hour hand.

The tower clock 1 also has a stepper motor 4, which is connected to the first hand Z1 via a first clock shaft W1. The first clock shaft W1 is firmly connected to the first hand Z1. The stepper motor 4 is not shown in FIGS. 2, 4 and 5.

The tower clock 1 also has an acceleration sensor 5 designed as a 2D acceleration sensor or as a 3D acceleration sensor, which is attached to the first hand Z1, as shown as an example in FIGS. 1 and 5, or is attached to the first clock shaft W1, as shown as an example in FIGS. 2 to 4.

The acceleration sensor 5 is designed as a passive RFID sensor transponder. This acceleration sensor 5 makes it possible to determine its orientation, i.e. in particular the inclination or angular position, in two or three dimensions, i.e. in the axis directions of a two-dimensional or three-dimensional coordinate system, via a reference to the acceleration due to gravity g of 9.81 m/s² Since the acceleration sensor 5 is attached to the first hand Z1 or to the first clock shaft W1, the orientation of the first hand Z1 and thus an actual hand position of the first hand Z1 can also be determined.

The tower clock 1 also has a reading unit 6 for contactless reading of the acceleration sensor 5. The reading unit 6 is designed as an RFID reading unit for reading the acceleration sensor 5, which is designed as an RFID sensor transponder. The reading unit 6 is arranged in such a way that it is within reading range of the acceleration sensor 5 at all times, i.e. in any position of the acceleration sensor 5. In particular, the reading unit 6 is arranged in a fixed position.

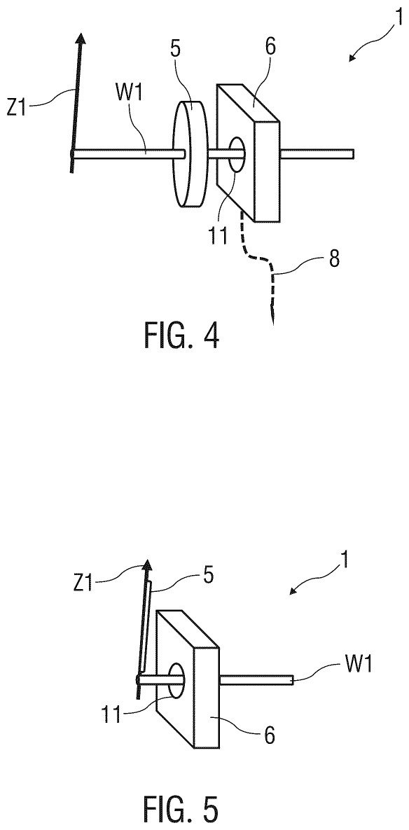

In addition, the tower clock 1 has a control computer 7 coupled to the reading unit 6 and to the stepper motor 4 (only shown in FIG. 1), which control computer 7 is designed to receive a time signal ZS, to receive a hand position signal PS of the acceleration sensor 5 read out by the reading unit 6 and to control the stepper motor 4 as a function of the time signal ZS and the hand position signal PS. The reading unit 6 is coupled in particular to the control computer 7 via a cable 8, shown as an example in FIG. 4.

The hand position signal PS of the acceleration sensor 5 contains, in particular, a statement regarding the respective hand position of the first hand Z1, in particular in the form of acceleration values in two or three dimensions resulting from the effect of the acceleration due to gravity on the acceleration sensor 5 or in the form of corresponding sensor values. In particular, it is intended that the control computer 7 determines the actual hand position from this hand position signal PS. The stepper motor 4 is then controlled by the control computer 7 as a function of the time signal ZS and of the actual hand position determined by means of the hand position signal PS if this actual hand position deviates from a hand position corresponding to the time signal ZS, at least if this deviation is above a predetermined limit.

In a method for operating the tower clock 1, it is thus provided in particular that the hand position signal PS is read out at predetermined time intervals of, for example, 30 seconds, an actual hand position is determined from this in the control computer 7, the determined actual hand position is compared in the control computer 7 with a hand position corresponding to the time signal ZS, if the deviation of the determined actual hand position from the hand position corresponding to the time signal ZS exceeds a predetermined limit, a number of steps of the stepper motor 4 corresponding to the deviation is calculated by the control computer 7, and the stepper motor 4 is controlled by the control computer 7 to execute the calculated number of steps.

Advantageously, a basic routine for self-calibration SK of the acceleration sensor 5 is provided for a respective 360° hand rotation. The reference signal is the gravitational acceleration g of 9.81 m/s². This compensates in particular for ageing of the acceleration sensor 5 and a temperature-dependent transfer function.

The tower clock 1 has, for example, a mechanical converter 9 via which the stepper motor 4 is connected to the first clock shaft W1, as shown by way of example in FIGS. 1 and 2.

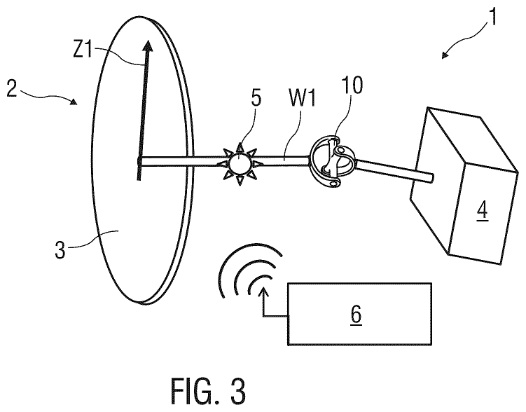

The tower clock 1 may have a cardan joint 10 between the first clock shaft W1 and an output shaft of the stepper motor 4 or the mechanical converter 9, as shown by way of example in FIG. 3.

As shown by way of example in FIGS. 4 and 5, the reading unit 6 can have a feed-through opening 11 for the first clock shaft W1 and can be arranged coaxially to the first clock shaft W1, wherein the feed-through opening 11 has a larger diameter than the first clock shaft W1 arranged guided through the feed-through opening 11. This is a structural form of the reading unit 6 for optimum mounting in the area of the first clock shaft W1.

As shown by way of example in FIG. 5, the acceleration sensor 5 can be elongated and/or arranged in an elongated housing and arranged on the first hand Z1. This is a structural form of the acceleration sensor 5 for optimum mounting on standard hands of tower clocks 1. For example, the acceleration sensor 5 and/or its housing has a length of 2 cm to 15 cm. The RFID sensor transponder is, for example, a UHF RFID sensor transponder with a dipole antenna at lambda-half or lambda-quarter with respect to the wavelength of the radio signal, in particular the hand position signal PS.

As shown as an example in FIG. 4, the acceleration sensor 5 can alternatively also be round and/or arranged in a round sensor housing and attached to the first clock shaft W1 coaxially to the first clock shaft W1. This is a structural form of the acceleration sensor 5 for optimum mounting on the first clock shaft W1, which is firmly connected to the first hand Z1.

In one embodiment, the mechanical converter 9 is connected to the second hand via a second clock shaft, with the first clock shaft W1 and the second clock shaft in the mechanical converter 9 being coupled to each other via a gear. In this embodiment, therefore, only the first hand Z1, for example the minute hand, is adjusted directly by the stepper motor 4. The second hand, for example the hour hand, is then also adjusted via the adjustment of the first hand Z1.

If the time display unit 2 has three hands, the mechanical converter 9 is advantageously connected to the second hand via the second clock shaft and to the third hand via the third clock shaft, whereby the first clock shaft W1, the second clock shaft and the third clock shaft in the mechanical converter 9 are coupled to each other via the gearing. In this embodiment, therefore, only the first hand Z1, for example the sweep hand, is adjusted directly by the stepper motor 4. The second hand and the third hand, for example the minute hand and the hour hand, are then also adjusted via the adjustment of the first hand Z1.

The control computer 7 is connected to a time signal generator (NTP server) and/or an operator server, for example, via a data transmission network, indicated schematically in FIG. 1 by a network output 12 on the control computer 7. In the age of digitalization, this solution enables practical and simple remote maintenance thanks to the network capability.

Deviations in the sensor characteristic curve, for example over the long term or the temperature, are advantageously compensated for by a self-calibration procedure. The prerequisite is that the acceleration sensor 5 performs at least one 180° rotation in the constant earth gravitational field and the gravitational constant at the respective earth point can then be used as a calibration reference. For this purpose, it is necessary to determine the maximum and minimum acceleration of the respective acceleration sensor 5, in particular of the respective acceleration sensor unit of the acceleration sensor 5, during a rotation and to program the calibration value determined therefrom into the acceleration sensor 5, in particular into the respective acceleration sensor unit of the acceleration sensor 5, or, for example, into the overall system of the tower clock or into the reading unit 6 or into the control computer 7.

In particular, it is intended that what has been described above with regard to the first hand Z1, in particular with regard to the determination of the hand position by means of the acceleration sensor 5, also applies to the second hand and, if present, also to the third hand. By applying the RFID anti-collision principle and the unique hand identification, i.e. the unique identification of the acceleration sensor 5 assigned to the respective hand, all acceleration sensors 5 can be read out with the same RFID reading unit.

Advantageously, the control computer 7, in particular the programmable control computer 7, in particular in the form of a controller, is used for the entire control of this asynchronous clock. The control computer 7 runs continuously, i.e. permanently, for the duration of the clock operation. It executes a program corresponding to the solution described, which in particular implements the procedure for operating the tower clock 1.

In this method for operating the tower clock 1, after the control computer 7 is started, for example, the usual setups for the operating system are first executed and, in particular, the time synchronization of the control computer 7 is also executed, which serves as the reference time (real time), i.e. as the time signal ZS. This time can be an internal quartz clock of the control computer 7, the time signal transmitter DCF77, the Internet time or the time reference of a GPS satellite.

Once this has been done successfully, the data from the acceleration sensor 5 is advantageously read out and the respective hand position is calculated in degrees, hours, minutes or seconds and compared with the real time, i.e. with the time according to the time signal ZS. If there is a difference, the number of steps of the stepper motor 4 forwards or backwards is calculated from this, in particular according to a transmission ratio of the clock gear, which is arranged in the mechanical converter 9, and the angular increments of the stepper motor 4. The transmission ratio and angular step size are advantageously adjustable parameters of the program. They therefore allow the program to be variably applied to different hardware components of tower clocks 1.

The acceleration sensor 5 is read and the stepper motor 4 is controlled until the specified limit is reached. In particular, the limit is specified as a function of the respective resolution of the hand position on the clock face 3.

This limit is advantageously a selection parameter of the program. Ideally, the controller reaches this limit with a program loop. This means that the deviation of the actual hand position from the hand position that should be present according to the time signal ZS and the resulting steps of the stepper motor 4 are advantageously calculated so that the actual hand position is within the limit after controlling the stepper motor 4 and executing the calculated steps.

Advantageously, the actual hand position is then determined again and its deviation from the hand position, which should be present according to the time signal ZS, is checked again. If the actual hand position is outside the limit, the required steps of the stepper motor 4 are calculated again and the stepper motor 4 is controlled accordingly in order to execute the calculated steps. This is advantageously repeated until the actual hand position is within the specified limit. Ideally, however, this is already the case after the first hand adjustment by means of the stepper motor 4, so that no repetitions are necessary.

This process is repeated at predetermined, preferably adjustable, time intervals, for example every 30 seconds. This time interval is sufficient for tower clocks 1 to achieve a reasonable accuracy of the time display, especially if the tower clock 1 does not have a sweep hand, but only a minute hand and hour hand. Energy savings can be achieved through this time interval. The solution described therefore works in a very energy-saving manner. The stepper motor 4, as the most energy-intensive element, is advantageously operated at a duty cycle of approx. 1:50 to 1:100.

All measured variables and adjustment variables, i.e. in particular executed steps of the stepper motor 4 as well as the determined hand position signals PS and/or the hand positions determined therefrom, are advantageously stored in a non-volatile data memory and are thus available for data analysis, in particular for the routine of self-calibration SK of the acceleration sensor 5. The acceleration sensor 5 advantageously has a simple option for entering calibration constants.

In order to avoid having to use elaborately calibrated acceleration sensors 5, a routine for self-calibration SK is carried out, for example, in particular as part of the method for operating the tower clock 1, which is carried out continuously, in particular cyclically, during operation of the tower clock 1 and/or during initial installation.

During the initial installation, for example, a self-calibration function is called up in the program, which first performs at least a 360° rotation of the first hand Z1 or the respective hand in order to determine the maximum and minimum accelerations, from which the calibration constants for the respective acceleration sensor 5, in particular for its acceleration sensor units, are determined. Once this has been carried out and meaningful values have been determined, normal clock operation can begin.

It is advantageous that this calibration routine can be performed again for each hand rotation in normal clock operation without having to perform a special 360° rotation of the hand again in deviation from normal clock operation, since all measured values for determining the maximum and minimum accelerations are available in the data memory, for example for an hourly rotation of the minute hand, as described above.

In particular, this procedure also means that temperature influences on the acceleration sensor 5 are automatically compensated for. It can be assumed that large temperature fluctuations on tower clocks 1 are slower than one hour. Experience has shown that the calibration values from the measurement in the minute hand can also be transferred to the acceleration sensor 5 of the hour hand if the same acceleration sensors 5 from the same production series are used.

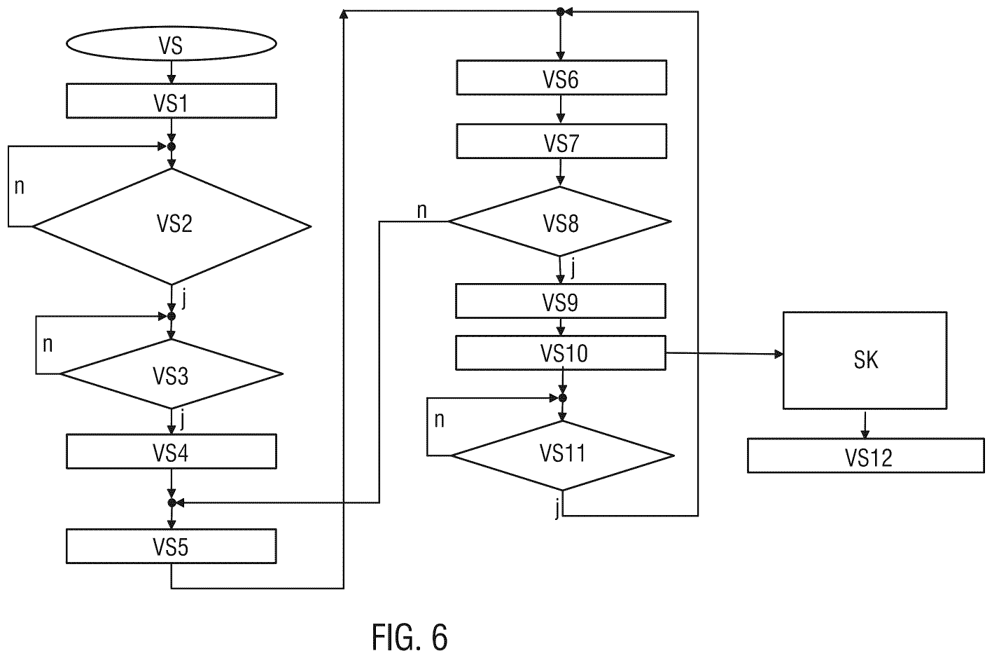

In the following, a sequence of an embodiment of the method for operating the tower clock 1 is described using the program flow chart shown in FIG. 6.

In the embodiment shown, the control computer 7 is started in a first process step VS1 after a process start VS.

In a second process step VS2, the system status and the time synchronization of the control computer 7 are tested. If problems are detected, indicated by the reference sign n for no, this second process step VS2 is repeated.

If everything is OK, marked with the reference sign j for yes, the acceleration sensor 5 is read out by means of the reading unit 6 in a third process step VS3. If the acceleration sensor 5 cannot be read out, marked with the reference sign n, the third process step VS3 is repeated.

If the acceleration sensor 5 has been read out, indicated by the reference sign j, the fourth process step VS4 uses the actual hand position determined from the read-out hand position signal PS and the time signal ZS to calculate the number of steps that the stepper motor 4 must perform so that the actual hand position corresponds to the hand position according to the time signal ZS or only deviates from it within the specified limit.

In a fifth process step VS5, the stepper motor 4 is controlled by the control computer 7 in order to execute the calculated number of steps.

The process steps VS1 to VS4 are used in particular for an initial basic setting of the displayed time of the tower clock 1. The further process steps VS5 to VS12 are then repeated at time intervals of, for example, 30 seconds in order to update the displayed time of the tower clock 1.

In a sixth process step VS6, the acceleration sensor 5 is read out.

In a seventh process step VS7, the number of steps that the stepper motor 4 must perform so that the actual hand position matches the hand position according to the time signal ZS or deviates from it only within the specified limit is calculated using the actual hand position determined from the read-out hand position signal PS and the time signal ZS.

In an eighth process step VS8, it is determined whether the specified limit has already been reached, i.e. whether the actual hand position is within the limit of the deviation from the hand position according to time signal ZS. If this is not the case, indicated by the reference sign n, the process is continued from the fifth process step VS5, i.e. the stepper motor 4 is controlled by the control computer 7 in order to execute the calculated number of steps. If the predetermined limit has already been reached, indicated by the reference sign j, a timer for the predetermined time interval is started in a ninth process step VS9.

In a tenth process step VS10, the actual values present, in particular with regard to the hand position signal PS and/or the hand position actually present and/or the deviation from the hand position according to the time signal ZS and/or the number of steps performed by the stepper motor 4, are stored in the data memory.

In an eleventh process step VS11, a check is made as to whether the next time interval has already been reached. If no, marked with the reference sign n, this check is carried out again in the eleventh process step VS11. If yes, marked with the reference sign j, the process is continued from the sixth process step VS6.

The predetermined limit of the deviation of the actual hand position from the hand position according to the time signal ZS is, for example, one degree, in particular for the first hand Z1, which is designed as a minute hand. This corresponds to a deviation of 10 seconds.

The time interval is 30 seconds, for example, as already mentioned.

The control computer time, i.e. the time used by the control computer 7, in particular also for the time signal ZS, corresponds in particular to real time.

Reading out the acceleration sensor 5 means, in particular, determining the inclination of the hand and thus the position of the hand and thus calculating the actual minute position of the minute hand or the actual hour position of the hour hand.

The calculation of the steps of the stepper motor 4 serves to specifically control the stepper motor 4 to compensate the actual hand position, i.e. the determined actual hand position according to the read-out hand position signal PS, to the real time, i.e. to the hand position according to the time signal ZS.

The actual values stored in the data memory in the tenth process step VS10 can be used for the self-calibration SK of the acceleration sensor 5, as already described above. In a twelfth process step VS12, determined calibration values are written to the acceleration sensor 5.

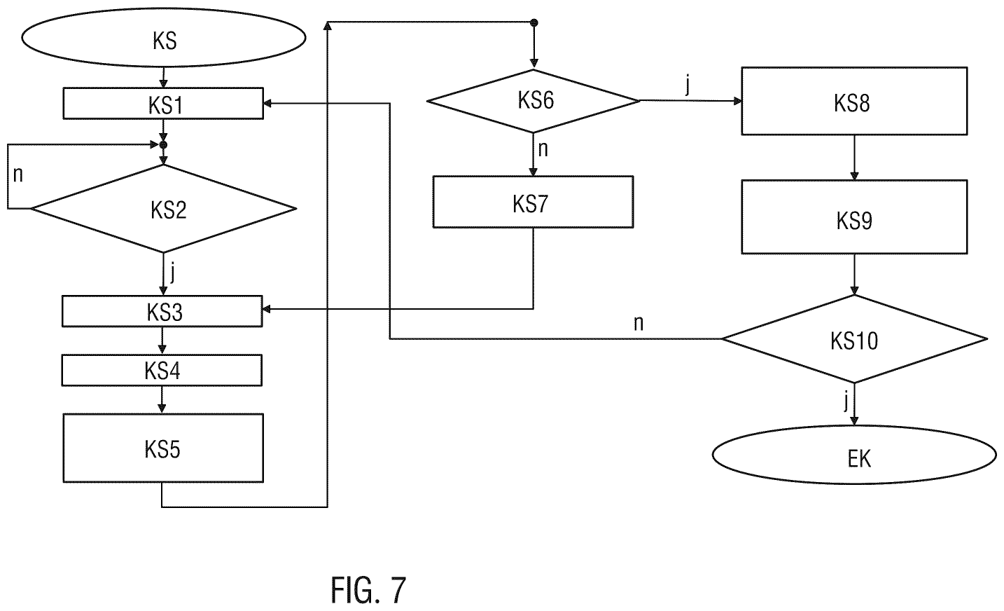

FIG. 7 shows a program flow chart of a sequence of an embodiment of a self-calibration procedure, which is carried out during an initial installation of an acceleration sensor 5 on the tower clock 1 and by which this acceleration sensor 5 is calibrated. This self-calibration procedure makes it possible to dispense with the costly and time-consuming prior calibration of acceleration sensors 5 and instead initially install uncalibrated acceleration sensors 5 on the tower clock 1, which are then calibrated using the self-calibration procedure.

After a calibration start KS, the control computer 7 is started in a first calibration step KS1.

In a second calibration step KS2, the acceleration sensor 5 is read out by the reading unit 6 and it is checked to see whether the acceleration sensor 5 provides relevant values, in particular a relevant hand position signal PS. If no n, then the second calibration step KS2 is repeated. If yes j, then the acceleration sensor 5 is read out by the reading unit 6 in a third calibration step KS3. In a fourth calibration step KS4, an angular position of the acceleration sensor 5 is calculated using the read-out values, in particular using the read-out hand position signal PS. In a fifth calibration step KS5, the actual values are stored, in particular an acceleration in the x-direction and an acceleration in the y-direction of the two-dimensional or three-dimensional coordinate system and the calculated angular position.

In a sixth calibration step KS6, it is checked whether a full 360° rotation of the hand with the acceleration sensor 5 has already been achieved. If no n, in a seventh calibration step KS7, the stepper motor 4 is controlled by the control computer 7 to perform a predetermined number of steps, and then the self-calibration procedure is continued from the third calibration step KS3. If yes j, i.e. if it is determined in the sixth calibration step KS6 that a full 360° rotation of the hand with the acceleration sensor 5 has already been achieved, the calibration values are calculated in an eighth calibration step KS8, in particular from the minimum and maximum of the acceleration in the x-direction and from the minimum and maximum of the acceleration in the y-direction and the associated angular positions.

In a ninth calibration step KS9, the calculated calibration values are written to the acceleration sensor 5. The calibration is thus advantageously performed to ±1 g (g=acceleration due to gravity of 9.81 m/s².

In a tenth calibration step KS10, the acceleration sensor 5 is read out again by the reading unit 6 and it is checked whether the acceleration sensor 5 also supplies relevant values after calibration, in particular a relevant hand position signal PS. This serves in particular to check whether the acceleration sensor 5 has been written to correctly and whether it functions and can be used.

If this is not the case, indicated by the reference sign n, the self-calibration procedure is continued from the first calibration step KS1. Otherwise, i.e. if the readout of the accelerometer 5 and the check as to whether it provides relevant values was successful, indicated by the reference sign j, the end EK of the self-calibration procedure is reached.

### LIST OF REFERENCES

1 Tower clock
2 Time display unit
3 Clock face
4 Stepper motor
5 Acceleration sensor
6 Reading unit
7 Control computer
8 Cable
9 Mechanical converter
10 Cardan joint
11 Feed-through opening
12 Network output
EK end
j yes
KS Calibration start
KS1 to KS10 Calibration step
n no
PS Hand position signal
SK Self-calibration
VS Process start
VS1 to VS12 Process step
W1 first clock shaft
Z1 first hand
ZS time signal

What is claimed is:

1. A tower clock, comprising
a time display unit with a clock face and at least two hands,
a stepper motor which is connected to the first hand via a first clock shaft,
an acceleration sensor designed as a 2D acceleration sensor or as a 3D acceleration sensor, which is attached to the first hand or to a part mechanically connected directly to the first hand,
a reading unit for contactless reading of the acceleration sensor, and
a control computer coupled to the reading unit and to the stepper motor, which is designed to receive a time signal, to receive a hand position signal of the acceleration sensor read out by the reading unit and to control the stepper motor as a function of the time signal and of the hand position signal.

2. The tower clock according to claim 1,
having a mechanical converter, via which the stepper motor is connected to the first clock shaft.

3. The tower clock according to claim 1,
comprising a cardan joint between the first clock shaft and an output shaft of the stepper motor or the mechanical converter.

4. The tower clock according to claim 1,
wherein the reading unit has a feed-through opening for the first clock shaft and is arranged coaxially to the first clock shaft, wherein the feed-through opening has a larger diameter than the first clock shaft arranged guided through the feed-through opening.

5. The tower clock according to claim 1,
wherein the acceleration sensor is elongated and/or is arranged in an elongated housing and is arranged on the first hand.

6. The tower clock according to claim 1,
wherein the acceleration sensor is round in shape and/or is arranged in a round sensor housing and is attached to the first clock shaft coaxially to the first clock shaft.

7. The tower clock according to claim 1,
wherein the reading unit is coupled to the control computer via a cable for data transmission and electrical power supply.

8. The tower clock according to claim 2,
the mechanical converter being connected to the second hand via a second clock shaft, the first clock shaft and the second clock shaft in the mechanical converter being coupled to one another via a gear.

9. The tower clock according to claim 2,
wherein the mechanical converter is designed as a distributor, via which the stepper motor is connected to a further first hand of at least one further time display unit via a further first clock shaft.

10. The tower clock according to claim 1,
wherein the control computer is connected to a time signal generator and/or to an operator server via a data transmission network.

11. A method for operating a tower clock according to claim 1, wherein the hand position signal is read out at predetermined time intervals, an actual hand position is determined therefrom, the determined actual hand position is compared with a hand position corresponding to the time signal, if the deviation of the determined actual hand position from the hand position corresponding to the time signal is above a predetermined limit, a number of steps of the stepper motor corresponding to the deviation is calculated and the stepper motor is controlled to execute the calculated number of steps.
